(19) United States
(12) Patent Application Publication
(10) Pub. No.: US 2014/0277754 A1
(43) Pub. Date: Sep. 18, 2014

(54) Integrated Sustainable Energy System

(71) Applicant: Edward F. Miller, Andes, NY (US)

(72) Inventor: Edward F. Miller, Andes, NY (US)

(73) Assignee: TMG ENERGY SYSTEMS, INC., Rye, NY (US)

(21) Appl. No.: 14/215,916

(22) Filed: Mar. 17, 2014

Related U.S. Application Data
(60) Provisional application No. 61/791,391, filed on Mar. 15, 2013.

(51) Int. Cl. G05B 15/02

(52) U.S. Cl. CPC G05B 15/02
USPC 700/275

(57) ABSTRACT

A method of processing information obtained from Cogeneration and Trigeneration systems serving commercial and residential applications to trend, affect maintenance decisions of the mechanical infrastructure and predict malfunctions in the mechanical infrastructure.

### FIELD OF THE INVENTION

The present invention relates to the field of Supervisory Control and Data Acquisition (SCADA) for Cogeneration (thermal and electric) and Trigeneration (thermal, electric and cooling) systems serving commercial and residential applications.

### BACKGROUND OF THE INVENTION

Mechanical systems have been monitored in some form or another since the 1970's. In the late 1980's, as the price of computing power became more accessible, more and more physical plants looked towards computers (as opposed to pneumatics) to control the day to day operations of their mechanical systems. These systems became known as Building Management Systems (BMS) or Automatic Temperature Control Systems (ATC Systems).

BMS control roughly 75% of all commercial buildings' mechanical infrastructure and are able to perform a variety of tasks. Among these are system monitoring, hardware control, trending, and management of the day-to-day mechanical infrastructure of the site. These BMS typically reside on-site and are monitored locally by facilities personnel. Depending upon the brand and sophistication of the controllers installed in the BMS, the BMS may be monitored remotely by a company with proprietary rights to the hardware and software. This monitoring is done under a mutual contractual agreement which benefits both parties.

On-site monitoring and control of BMS systems is very popular among facilities managers because it decreases training, personnel costs and restricts day-to-day operations of the physical plant to selected individuals, as opposed to allowing access to the whole engineering department. This provides more security over the day-to-day running of the mechanical infrastructure and thus, greater efficiency.

The technology of cogeneration has existed since the late 1800s when Thomas Edison used it to power his first electric plant. Cogeneration (Cogen) or Combined Heat and Power (CHP) is the production of heat and electricity, chilled water from an absorber (using hot water or an engine) and hot water or steam from a boiler associated with heat generated by a cogen unit—all generated using natural gas. With regard to cogeneration in America, there was a huge resurgence in the 1980s due to a great deal of easily available government money. Pushed by the favorable experience and reputation cogeneration had enjoyed in Europe, the United States jumped on the cogeneration bandwagon and contractors began installing cogeneration plants everywhere. Unfortunately, a great deal of these installers were not properly trained or the sites themselves were not viable for cogeneration and it became no wonder that the cogeneration plants did not perform as expected. As a result, the idea of cogeneration left a bad taste in the mouths of most facility management personnel, even though it promised to provide huge discounts in their electric and heating costs.

The problem facing cogeneration was now its reputation, not its ability to perform. A well-installed cogeneration system can save a site about 40% off of its annual energy bills. This obviously is an incredible amount, but most facilities were hesitant to invest in a system with a questionable reputation, regardless of the return. One solution came to light, however, and that was the On-Site Utility, or leased model of cogeneration.

The On-Site Utility model provided facilities with all of the financial rewards and none of the risks. A well-trained company would assess the site and, if it proved viable, provide an engineered cogeneration system that it owned and operated, billing the facility for only the energy it used with no installation or maintenance risk. This proved to be a very attractive model for property owners and, coupled with incentives from state and federal bodies, lent a very positive aspect towards cogeneration. As of the new millennium, cogeneration has garnered a well-deserved reputation for being an energy-efficient way to curb utility costs with little or no exposure to capital and maintenance costs for the facility.

Most cogeneration units come factory set with some sort of communication ability already installed. This provides limited remote dial-in capability to see the major functions of the unit, such as power produced, heat produced, engine diagnostics, etc. What the cogeneration units typically do not provide is a communication system that will include the actual cogeneration plant—all of the valves and temperature sensors and other controls that make the system work.

In order for the On-Site model to be efficient—in its performance, its billing and its maintenance, communication is a key element. Since typical CHP systems do not provide an extensive communications platform, one needed to be created and cogen installers turned to BMS. BMS already had the tools needed to interface with the CHPs and they were designed to control and monitor valves and all other types of mechanical controls. The only drawback is that the major brands are proprietary which means that another contractor is now involved. What is needed is a way to monitor and acquire data without employing third-party devices.

### BRIEF SUMMARY OF THE INVENTION

In accordance with one embodiment of the present invention, data from the major equipment (cogens, absorbers, chillers, boilers, etc.) will be collected at the site via Program Logic Controller (The Controller). At the same time, The Controller will be able to control all manner of major equipment as well as all passive and active peripherals (valve actuators, switches, temperature sensors, flow meters, etc.) automatically and from remote command override.

In some embodiments of the present invention, existing controller logic may be used, if available on the major equipment. These include cogens, absorbers, chillers and boilers. These logic controllers would be integrated into The Controller logic as part of the entire control structure for the entire cogen plant.

In some embodiments of the present invention, wireless structured data transfer devices (routers) may be utilized in order to maintain an open path of communication with The Controller in order to enable the entire plant system to share data.

The system will utilize Microsoft's SQL database engine for all database requirements. Other database platforms may perform a refining process during data transfer from the Site to the SQL server.

### BRIEF DESCRIPTION OF THE DRAWING

FIG. 1 is a flow chart describing the process of data acquisition to data assimilation. This is a back bones description of the invention's data assimilation process only. This does not describe hardware control.

FIG. 2 is a flow chart describing the control input/output process of The Controller. This drawing describes the flow of the hardware control.

### DETAILED DESCRIPTION OF THE INVENTION

The invention will begin to operate by gathering data at the inception of the project during the profiling phase, during which the existing systems are analyzed. That information is input into the invention in order to begin to see the site's viability in comparison to the archival data stored in the database. Information such as temperature, flow and efficiency of existing equipment will all play a role into establishing a hard, firm database upon which a conclusion can be drawn about the project's feasibility. The feasibility of a site is directly coupled to the amount of savings we will assume from it, so a careful study is paramount. The site survey component of the invention calculates hours of operation, building loads, parasitic loads, and all associated costs of a given project while taking the utility electric demand rate schedule into consideration.

As per FIG. 2, The Controller will send and receive data from various parts of the mechanical system(s) under its control. These may include valve position, temperature(s), Variable Frequency Drive (VFD) data, pump status, valve position, cogen data and any facility peripherals necessary for the system to function properly (405-430). The on-board program will operate the system on a day-to-day basis, making adjustments as necessary. With regard to data acquisition, FIG. 2 depicts the gathering of data from various types of devices and equipment. Every five to fifteen minutes, the contents of The Controller's flash drive is uploaded, via a router 145 and a secure connection, to the servers in the Network Operations Center (NOC) where it will be processed through a data translation algorithm 205 which formats the data into SQL Records 210. After that, according to FIG. 2, the data is then sorted and filed into the database accordingly depending upon the type of data 215. Certain data will immediately update the Graphic User Interfaces (GUI) 320 to be viewed by technicians or clients. All other data will go to data analysis 325 for further break-down and querying.

The invention will utilize The Controller 140 to control any or all of these devices in order to adjust for efficiency or compensate for a deficiency. The Controller is capable of monitoring the systems as well as being controlled remotely or utilizing its own on-board program to maintain a well-balanced system. The Controller is the first line of defense against any malfunctions and, after detecting any errors, will broadcast these errors to the NOC and the Artificial Intelligence Module (AIM) 315 to be disseminated, while at the same time notifying technicians via cell phone, text messaging, etc.

As per FIG. 1, the invention will then transmit all data currently in memory to The company's headquarters in five to fifteen minute “buckets” utilizing an on-site router with a dedicated IP address. This transmission will occur all year-round without interruption. The data transfer will be initiated by a retrieval algorithm in The company's headquarters and be staggered so that there will not be an excessive amount of data being uploaded at one time. The invention will also adjust for optimal data throughput by utilizing fractional T-1 lines in order to load balance the data retrieval and compensate for any disproportionate loads. The Controller 140 will also transmit a Comma Separated Value (CSV) text file containing a list of files transmitted and their sizes to be used for comparison during retrieval.

As per FIG. 1, When the data reaches The company's servers, after passing a comparison test to verify the integrity of the data, the invention will process the data through a translation algorithm 205 capable of converting the raw machine values uploaded from the sites into SQL recognizable data. The invention will then initiate a data dump into the SQL server 210 where it will be entered as new records in the appropriate site. This shall be common to all sites.

The invention can now make the data available to the GUI system 320, the billing system 310, the demand system 320 as well as the AIM 315, and all other system peripherals, as shown by FIG. 1. If required, the invention could perform the entire data retrieval sequence in real time, all the time; however, the demand on bandwidth prohibits this from a cost based aspect. The company is entertaining military options for which this would be a requirement so this functionality will be as mentioned.

Lastly, FIG. 1 depicts the most important part of the invention and what makes the invention unique—its AIM 315. This software feature will allow the invention to perform in a way that no other BMS or data acquisition suite has ever made possible. The AIM will poll all data and affect the way maintenance decisions are made by predicting malfunctions well before they happen. It will aid in demand capture and the scheduling of unit runtime to coincide with that. It will observe trends that allow decisions to be made regarding future projects, just to name a few. By analyzing all the data coming in from all the sites, the AIM will automate the entire process of data acquisition, processing with software-based intelligence and allow the control of the sites to be governed by a system that will be able to make intelligent decisions about every aspect of running the sites, gathering data and utilizing the knowledge garnered from that data.

The AIM will also be a fundamental and integral part of the system control process. Because it will be monitoring all data all the time, and make decisions based on said data, it will be much better equipped than a human or any of the memory-resident programs running in The Controller to guide the system(s) and immediately process any information. This type of action/reaction control system is called a Proportion, Integral, Derivative loop, or PID loop. This type of control changes the system slightly and then reacts to the response of that change with another change and so on, until the system(s) has reached optimum operational performance. What makes this different from typical controller-based PID loops is the sheer amount of variables at the invention's disposal. Whereas a normal PID loop is responsible for analyzing one part of a system, say a valve and a temperature sensor, the invention will analyze the variables in the entire system and make the necessary modifications to the system to establish and maintain a smooth running system. For instance, if a cylinder head on a cogen motor has been replaced twice prematurely and the AIM sees that the system is coming up on the same time period for the heads to malfunction, it might look to see if a demand capture is imminent, and if not, shut the system down and notify the technicians. This is an ability a BMS or a stand-alone PLC simply does not have.

Demand Response 330

The invention is the first sustainable program capable of capturing electrical demand for third party owner/operators. Electrical demand refers to the maximum amount of electrical energy that is being consumed at any one time. This usage is called the demand on a system and is expressed in kilowatts (kW). Demand is monitored in five to fifteen minute intervals, depending on the market, in which the customer is charged for the highest interval average recorded on the demand meter. The demand rate can vary by seasons, days and even hours. The invention will sync with the utilities' time clock for demand and take into consideration all demand schedule(s) for that site. The invention constantly monitors every electrically generating site for demand. The invention will issue work orders to cease and desist any and all maintenance for the period of time needed to capture demand. Any demand captured will be logged in the site's database to be used for historical and billing purposes.

Maintenance 335

The invention will keep track of an asset's production and flag machines as they come upon routine maintenance times and maintain optimum performance constructed upon a probability-based learning algorithm. Less unscheduled maintenance means more efficient equipment and higher savings for that site. Every five to fifteen minutes, the invention shall review the data looking for anomalies and comparing runtimes to equipment maintenance logs. The invention shall then issue work orders based upon routine maintenance requests or emergency situations. By ensuring that maintenance downtime does not prevent The company from capturing demand, the invention is able to increase profit margins by capturing demand ourselves.

Billing 310

The invention seamlessly integrates itself into the customer monthly billing cycle. Because all data is downloaded in fixed portions of time, the degree of accuracy with which the billing is performed is paralleled only by the utility company. The invention shall provide a billing interface for which each site may be billed on a monthly basis. This billing module shall consist of a SQL back end and an MS Access report. The invention shall populate the report with kWh, kW and BTUs/Therms per site. Additionally, the invention shall provide an export/interface to QuickBooks and/or other accounting software for billing, maintenance costs and operational costs for accounting purposes.

Carbon Credits 350

All sustainable systems shall have their runtimes tracked against the manufactures' output specifications so as to provide a real and constant record of carbon emission savings. Carbon Credit & Offsets shall be recorded and maintained in the active site database. These credits and offsets tie in with one of the fundamental parts of our business model, which is to help provide an additional “green” benefit to our customers and an increased economic benefit to The company. Milestone reports shall be issued quarterly.

Incentives 345

The invention is also used as an aid in the capture of incentive monies. Incentives are federal, state, local or utility based programs set in place to encourage the use of “green” and sustainable energy sources. All incentive programs have milestones that must be met in order to capture the incentive monies. All sustainable systems shall have the ability to have their respective incentive programs tacked. These incentives have certain requirements that must be met in order to be satisfied. Among these are run-time, production, increased efficiency and demand management. Upon reaching a critical date, the invention shall issue a warning and monitor the respective site(s) to ensure requirements are met.

Graphic User Interface 320

As soon as the incoming data is confirmed as viable, in conjunction with the invention, the data will write to the GUI interface and make ready to display the updated information on an HTML-based GUI interface to the NOC and the client accessible section of The company's web site. The GUI in the NOC shall consist of all pertinent site data while the client side version will be sanitized to some extent as to provide only kW, BTUs, Therms and limited temperatures. The customer dashboard will initially be read-only but might include some interaction as the invention progresses. The invention's GUI interface will consist of a dashboard that shall include all temperature points, all motor speeds, all operating parameters, all valve positions, machine status, run hours, etc. as well as direct control of the equipment as engineered into the invention for that particular site. The company uses this interface for quick and easy snapshot views of any site's performance. This allows for additional monitoring of trouble sites as well as day to day monitoring of new installations.

The present invention may be embodied in other specific forms without departing from its spirit or essential characteristics. The described embodiments are to be considered in all respects only as illustrative and not restrictive. The scope of the invention is therefore indicated by the appended claims rather than by the foregoing description. All changes which come within the meaning and range of equivalency of the claims are to be embraced within their scope.

In addition, it should be understood that the figures described above which highlight the functionality and advantages of the present invention are presented for example purposes only and not for limitation. The exemplary architecture of the present invention is sufficiently flexible and configurable, such that it may be utilized in ways other than that shown in the figures. It will be apparent to one of ordinary skill in the art, how alternative, functional, logical or physical partitioning and configurations can be implemented to achieve the desired features of the present invention. Also, a multitude of different constituent modules, steps or names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in multiple various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like: and adjectives such as “conventional,” “traditional,” “normal” “standard,” “known” and terms of similar meaning should not be construed as limiting the time described to a given time period or to an item available as of a given time, but instead should be read to encompass conventional, traditional, normal or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent.

Additionally, the various embodiments set forth herein are described in terms of exemplary block diagrams and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Further, the purpose of the Abstract is to enable the U.S. Patent and Trademark Office and the public generally, and especially the scientists, engineers, and practitioners in the art who are not familiar with patent or legal terms or phraseology to determine quickly from a cursory inspection the nature and essence of the technical disclosure of the application. The abstract is not intended to be limiting as to the scope of the present invention in any way.

While the present invention has been described in conjunction with specific embodiments, those of normal skill in the art will appreciate the modifications and variations that can be made without departing from the scope and the spirit of the present invention. Such modifications and variations are envisioned to be within the scope of the appended claims.

1. A method of processing information obtained from mechanical infrastructure and controlling said mechanical infrastructure comprising the steps of:
placing sensors on components of said mechanical infrastructure;
obtaining data from said mechanical infrastructure;
translating said data using a translation algorithm;
saving said translated data in a database;
incorporating said translated data into an artificial intelligence module wherein said artificial intelligence trends, affects maintenance decisions of said mechanical infrastructure and predicts malfunctions in said mechanical infrastructure.

2. The method of claim 1 wherein the infrastructure includes but is not limited to a Cogeneration, a Chiller, an Absorber and a Boiler.

3. The method of claim 1 wherein said data includes valve position, temperature(s), Variable Frequency Drive (VFD) data, pump status, valve position and cogen data.
